(19) United States
(12) Patent Application Publication
(10) Pub. No.: US 2011/0198356 A1
(43) Pub. Date: Aug. 18, 2011

(54) Paints to go a.k.a paint stay

(76) Inventor: Regina Concepta Lee, Souderton, PA (US)

(21) Appl. No.: 12/660,015

(22) Filed: Feb. 12, 2010

Related U.S. Application Data
(63) Continuation-in-part of application No. 12/590,983, now abandoned.

(51) Int. Cl. B05C 21/00

(52) U.S. Cl. 220/570; 220/200

(57) ABSTRACT

A palette in which one can store paint in individual paint pots directly on the palette. Each paint pot has an air tight lid that keeps the paint safely secure when not in use. The air tight lid seals the paint and keeps it from drying out for an extended period of time. This also makes the palette easy to stow and carry knowing the paint will not spill when the lid is securely sealed in place. This also allows for easy clean up of excess paint when finished using the palette.

### BACKGROUND OF THE INVENTION

1. Field of the Invention

This invention relates to an easy stow and use of paint and palette for the individual artist, both young and old.

2. Objects of the Invention

The primary object of the present invention is for keeping paints of all types secure when not in use. It is to improve the portability of both paint and palette in one convenient system that is easy to maintain and afford.

3. Summary of the Invention

This invention provides an easy way to transport the paint and palette together. While conveniently storing the paint with air tight secure lids for later use by the artist.

### DESCRIPTION OF THE DRAWINGS

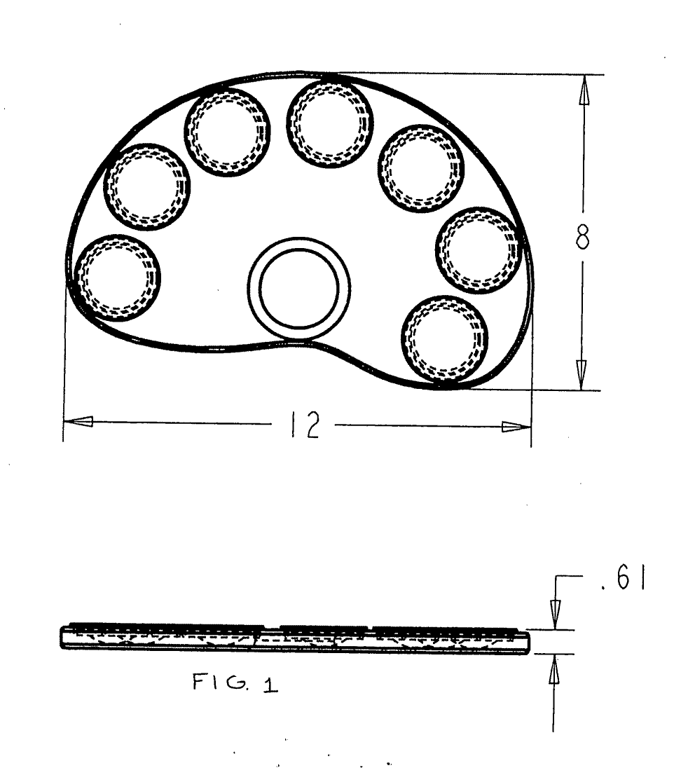

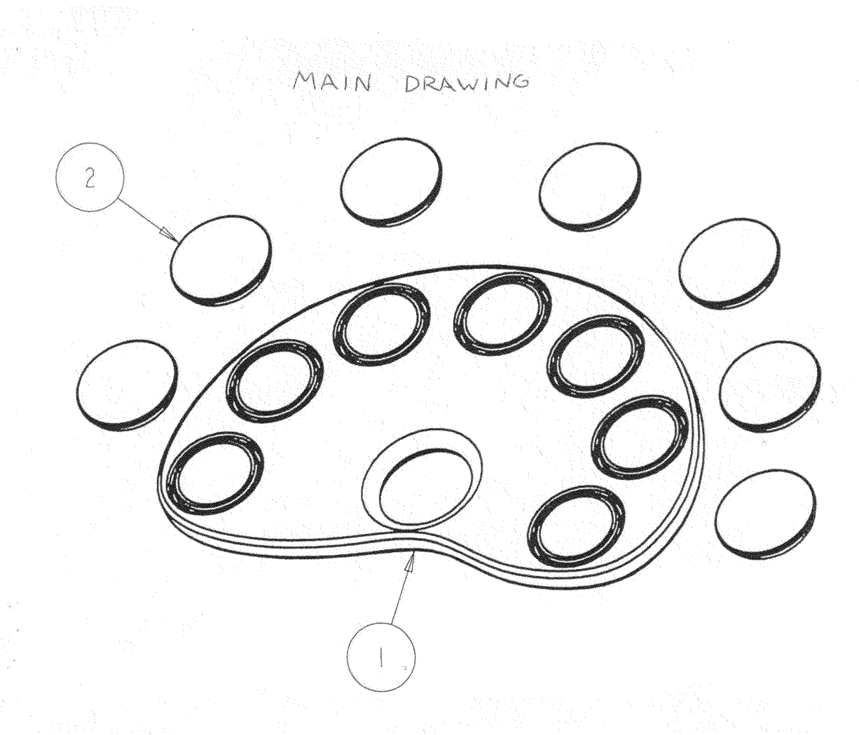

In Main drawing, FIGS. 1 & 2, it is showing the entire perspective view of both the palette and the lids, with slotted lines displaying how the lids would fit onto the paint pots embedded in the palette.

In FIG. 1 it shows the general dimensions of the lid and how it would fit over the paint pot compartments embedded in the palette.

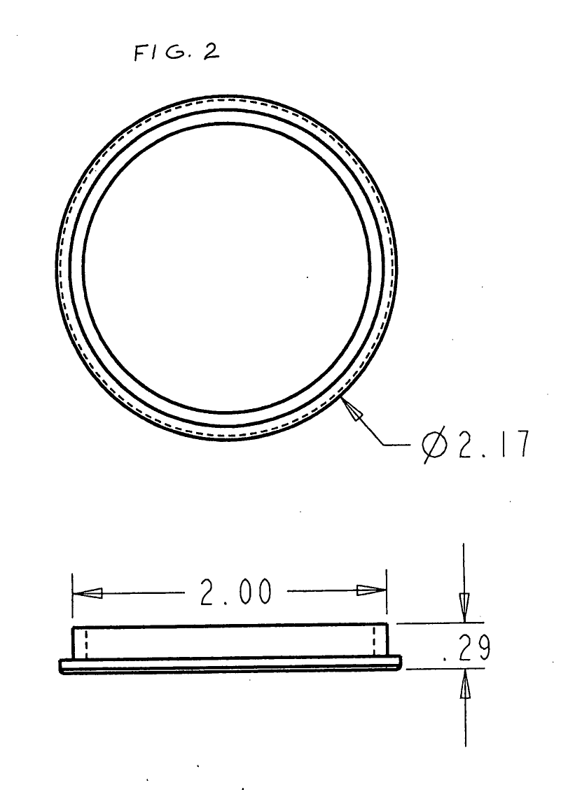

In FIG. 2 it shows the general dimensions of the paint pot compartments in the palette.

Note: Both FIGS. 1 & 2 show general dimensions of the lid, compartments and the palette which can be altered to any reasonable size which can be determined by the manufacturer.

What is claimed:

1. ‘Paints To Go’ can hold paint securely to be transported without spilling the paint when carried.

2. A. Each individual paint pot has a secure air tight lid which will stay in place.
B. Each individual paint pot will not leak when air tight lid is secure.

3. When paint pot lids are securely in place the palette can be wiped off or rinsed under water to clean excess paint without disrupting or diluting the paint within the secured paint pot.
